(19) United States
(12) Patent Application Publication
(10) Pub. No.: US 2026/0344712 A1
(43) Pub. Date: Nov. 5, 2026

(54) Steam Cabinet

(71) Applicant: Chris Deakin, Spearman, TX (US)

(72) Inventor: Chris Deakin, Spearman, TX (US)

(21) Appl. No.: 19/337,101

(22) Filed: Sep. 23, 2025

Related U.S. Application Data
(60) Provisional application No. 63/698,665, filed on Sep. 25, 2024.

(51) Int. Cl. A23L 5/10; A23L 5/00

(52) U.S. Cl. CPC A23L 5/13; A23L 5/55

(57) ABSTRACT

A system and method for wetting is disclosed. The system includes a steam cabinet having a steam vent and a steam chest. There is a chest vent which is coupled to a header. The header collects excess steam. The header is coupled to a condenser which condenses the steam. The condenser is coupled to an auger. The auger mixes dry corn with a steam stream and a hot water stream to wet the corn. The otherwise wasted steam has entrained heat which can be used in the wetting process. This results in reducing the wasted heat stream, conserving the heat and the water. This also results in increased absorption of the water by the corn.

### PRIORITY

The present invention claims the benefit of priority to U.S. Provisional Patent Application 63/698,665 filed on Sep. 25, 2024, the entirety which is hereby incorporated by reference.

### BACKGROUND OF THE INVENTION

### Technical Field

The present invention relates to a system and method for a steam cabinet.

### Description of Related Art

Steam is utilized in the flaking process. However, steam, and therefore the entrained heat, is typically wasted. Consequently, there is a need for an improved flaking system.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of the unit in one embodiment;

FIG. 2 is a schematic view of a steam vent in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

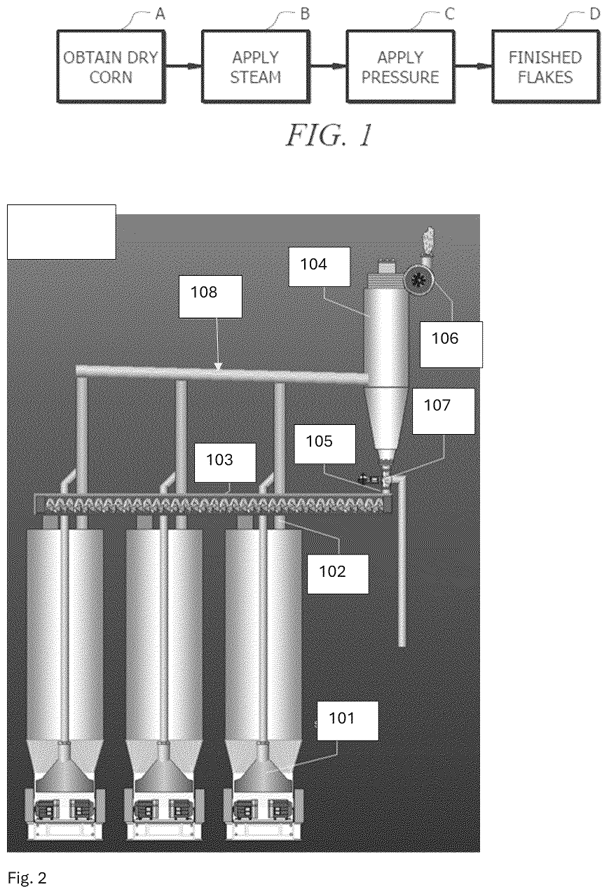

FIG. 1 is a schematic flow chart of the method of making flakes in one embodiment. This process is simplified for explanatory purposes. First, the process starts with obtaining corn. The moisture content of the obtained corn will depend upon a variety of factors including the location of the corn, the time of the year, etc. Corn which has been obtained closer to harvesting time will have a higher moisture content than corn which has been stored in a storage container for several months. The dry corn can have a moisture content which ranges from about 10% to about 16% by weight.

After obtaining the dry corn, steam is applied to heat and wet the corn to a desired temperature and moisture content. The desired moisture content can depend upon the desired content of the final flakes, but the moisture content typically ranges between about 18-20% by weight.

Like the moisture content, the desired temperature can also vary depending upon the desired characteristics of the final flakes. In one embodiment sufficient steam and/or heat is added to gelatinize the corn. A gelatinized corn results in a product which can be more efficiently digested by livestock. In one embodiment the corn is heated to a temperature of about 210 °F.

After heating and wetting the corn to the desired moisture content, the hot and wet corn is delivered to the roller system where pressure is applied via the rollers. This process applies pressure and sets the thickness of the final flake. The thickness of the final flake effects many of the final characteristics of the final flake, including density. In one embodiment, the goal is to achieve consistent starch availability. Starch availability can range, but in one embodiment the system and method produce consistent starch availability of 68% or higher. In one embodiment the system produces consistent starch availability of 70% or higher. Starch availability depends upon several factors including moisture, heat retention, pressure, corn quality, and others.

FIG. 2 is a schematic view of a steam vent in one embodiment. Previously, the excess steam was vented to the atmosphere. Put differently, all excess steam was allowed to escape and be vented to the atmosphere. However, the excess steam has significant entrained heat. By venting the excess steam to the atmosphere, this heat, which was introduced into the flaking process, is wasted. The heat added to the system to create steam requires significant energy to do so. This energy can be created by burning fuel, using electric heating sources, etc. The point is that by wasting entrained heat within excess steam, energy is wasted.

If a system can reduce excess energy waste, then the amount of energy required for a system can likewise be reduced. If fuel is burned, as an example, to create the steam, then less fuel can be utilized by the system which reduces waste. This reduces the consumption of fuel, such as hydrocarbons. By reducing the consumption of fuel, the by-products of fuel combustion, including green-house gases, is also reduced. Consequently, by reducing energy waste, the system can become more environmentally friendly. Similarly, if electric energy is utilized to create the steam, then the waste of electric energy is reduced.

In one embodiment, and discussed herein, the excess steam is not simply vented to the atmosphere. Instead, significant amounts of the inherent energy within the excess steam is recovered.

Traditionally, cold water is introduced into the auger 103, whereby it is mixed with other ingredients, such as corn. The temperature of the “cold” water can vary—it can be ambient or treated. Separately heating the water directly is not economical. The benefit obtained from heated water does not warrant the additional economic cost.

As noted, steam is added to wet and heat the corn mixture. As can be seen, in one embodiment, instead of cold water, hot water (condensed steam) is added to the corn. Thus, rather than having to heat the comparatively cooler material, hot water is added. This requires less energy to warm up to the desired heat, moisture content, etc. Heat is a catalyst to the reaction. Hot water also absorbs faster and more efficiently than cold water. Thus, adding heat results in a more desirable wetted product, and a faster wetting reaction.

Turning to FIG. 2, a flaker steam vent 101 is shown. The steam chest also has a chest vent 102. Previously, excess steam exited through both the flaker steam vent 101 and the chest vent 102. However, as can be seen, both the flaker steam vent 101 and the chest vent 102 are both directed to the header 108. Thus, the excess steam is collected in a header 108.

As shown, and in one embodiment, the header 108 is slanted in the direction of the condenser 104. This is because if any steam within the header 108 condenses, the condensed liquid will be directed to the condenser 104.

The condenser 104 collects the excess steam which was previously released into the atmosphere. The condenser 104 utilizes comparatively cooler liquids to condense the liquid in the steam. The liquid from the condenser is at an elevated temperature as it retains much of the heat and energy it did while in the steam phase.

Various types of condensers 104 can be utilized. The condenser 104 can utilize a cooling liquid to cool the steam. In other embodiments, the condenser 104 uses a plurality of baffles and increased surface area to condense the steam. As noted, in one embodiment, the goal is to condense all or a partial fraction of the otherwise wasted steam stream.

The condensed steam exiting the condenser 104 has retained heat. As noted, that heat is utilized in the wetting process. The increased heat allows for greater absorption of the water compared to comparatively colder water. Aside from the heat, however, there are other benefits. One benefit is that the purity of the condensed water is greater than traditional input water. The input water can be hard water, which can comprise salts and other impurities. Such impurities reduce the absorption rates of the water. Thus, using a condensed stream often results in water which has increased purity. The comparatively increased quality of water utilized in the auger increases absorption of water in the corn. This results in a faster reaction, and a better product.

The hot water 105 recently condensed is introduced into the auger 103. Hot water 105, steam, and/or cold water are added to the auger 103. These different water sources allow for the wetting of the corn with the introduction of heat and control of temperature. To that end, the amounts of each stream can be controlled with various control equipment to reach the desired absorption rate. The flow rates can be varied depending upon moisture content, desired temperature, etc. Thus, while in some embodiments all of the hot water 105 from the condenser is utilized, in other embodiments, some of the hot water 105 fraction will not be introduced into the auger 103.

The hot water 105 functions similarly to the cold water previously added to the system. However, as noted, the energy needed to raise the cold water to the temperature of the hot water is now eliminated. As noted, this has significant environmental benefits. Aside from environmental impacts, the system and method has many economic advantages as well. Because energy is captured and re-used, less energy is required in the steam chest. This results in economic savings. Thus, the system and method has significant environmental and economic benefits.

Further, as noted, aside from environmental and economic advantages, the higher temperature water 105 leads to increased absorption rates. Additionally, the water is often at a higher quality which has less impurities, also resulting in increased absorption. This increases both the speed of the process as well as the quality of the final product.

As shown, in one embodiment the condenser 104 is coupled to a fan 106. The fan 106 creates a negative pressure within the header 108 which helps draw the steam into the condenser.

The condenser 104 can comprise virtually any condenser known in the art. This can include water cooled condensers whereby water flows through tubes which condense the steam, as well as the baffle condensers discussed above. Those of ordinary skill will understand the various types, sizes, etc. of the condenser.

Also shown is a controller valve 107. This is a PLC controlled valve in one embodiment. The valve 107 can regulate how much, and how fast, hot water is added to the auger 103. While a controller valve 107 is illustrated, this is for illustrative purposes only and should not be deemed limiting.

It can be appreciated that in some embodiments, if the condensed steam volume is insufficient for the needs of the system, then supplemental water can be added in the auger 103. Thus, in some embodiments, the condensed steam exiting the condenser 104 is sufficient to provide all of the necessary water for the system to use in the flaking process, in other embodiments, the steam stream is supplemented with additional water. Even if supplemental water is needed for the system, the entrained heat within the hot water 105 source, the increased purity of the hot water 105, etc. results in increased absorption rates and a higher quality product, while reducing energy consumption and reducing energy waste.

Regardless of whether the water from the condenser 104 replaces, or is used in conjunction with supplemental water, the temperature of the water source in the auger 103 is increased significantly compared to the prior art. As noted, this reduces the heat required bring the mixture to the required temperature. This results in decreased operational costs as comparatively less fuel or electricity is required to heat the water source. As noted, aside from the decreased operational cost, there is an environmental impact as those fuels and heat sources are not burned or otherwise consumed.

While the invention has been particularly shown and described with reference to a preferred embodiment, it will be understood by those skilled in the art that various changes in form and detail may be made therein without departing from the spirit and scope of the invention.

What is claimed is:

1. A system comprising:
a steam vent and a chest vent, both coupled to a header;
wherein said header is coupled to a condenser;
wherein said condenser is coupled to an auger;
wherein condensate from said condenser is introduced into said mixer.

2. The system of claim 1 wherein said condenser comprises a fan.

3. The system of claim 1 wherein said header slopes downward to said condenser.

4. The system of claim 1 wherein said auger further comprises a steam inlet.

5. The system of claim 1 wherein hot water exits from said condenser, and wherein said condensate is introduced into said auger.

6. The system of claim 1 wherein steam is also introduced into said auger.

7. The system of claim 1 wherein cold water is also introduced into said auger.

8. A method of wetting corn comprising the steps of:
a) obtaining dry corn;
b) wetting said dry corn with a hot water stream and a steam stream in an auger;
wherein excess steam is collected in a header and directed to a condenser, and
wherein said hot water stream exits from said condenser.

9. The method of claim 8 wherein said dry corn has a moisture content of between about 10% to about 16% by weight.

10. The method of claim 8 wherein said wetting of step b) results in a corn with a moisture content of between about 18-20% by weight.

11. The method of claim 8 wherein said corn of step b) comprises a temperature of about 210 °F.

12. The method of claim 8 wherein said condenser comprises a fan which creates a negative pressure within said condenser.

13. The method of claim 8 wherein said header slopes downward to said condenser.
